(19) United States
(12) Patent Application Publication
(10) Pub. No.: US 2003/0137292 A1
(43) Pub. Date: Jul. 24, 2003

(54) Path sensor with an electromagnetic converter element

(76) Inventors: Wolfgang Welsch, Heidelberg (DE); Johannes Meiwes, Markgroeningen (DE); Juergen Boehling, Filderstadt (DE); Zeliko Jaitic, Muenchen (DE)

Correspondence Address: STRIKER, STRIKER & STENBY, 103 East Neck Road, Huntington, NY, 11743, US

(21) Appl. No.: 10/308,443

(22) Filed: Dec. 3, 2002

(30) Foreign Application Priority Data
Jan. 23, 2002 (DE) 10202320.4

(51) Int. Cl. G01B 7/14; G01B 7/30

(52) U.S. Cl. 324/207.2; 324/207.24; 324/207.25

(57) ABSTRACT

A path sensor includes at least one electromagnetic converter element and a magnetic circuit having at least one conductance piece (3, 4; 9, 10; 15, 16; 17, 18; 22, 23) and at least one magnet (2; 7, 8; 14; 20, 21). By movement of an element, an effect of the magnetic flux measurable by the converter element is affected. All parts of the magnetic circuit are immovable relative to one another during the path measurement, and the magnetic circuit and the converter element are moveable relative to one another. A change of the magnetic field plottable by the converter element is affected by a change of the air gap (d) in the magnetic circuit during the movement, and the conductance pieces of the magnetic circuit have a shape that conforms to the trajectory of the converter element, so that based on a change of the width (d) of the air gap in the trajectory (5; 6; 13), a predeterminable signal in the converter element is provided.

### BACKGROUND OF THE INVENTION

The present invention relates to a path sensor with at least one electromagnetic converter element for determining the movement of a component.

From DE 43 17 259 A1, a sensor arrangement for an angle of rotational is already known, in which a magnetic flow generator for producing a measurable magnetic flow is arranged in an electric control unit. Here, electromagnetic converter elements are provided, with which a change of the magnetic flow is detectable by means of the rotational movement of a magnetically conductive body.

With the known electromagnetic converter elements, a measuring effect is utilized, which then arises when the magnetic flux density in the converter elements is changed in dependence on the angle or path. This takes place in practice in that the magnetic circuit is made up of conductance pieces and a permanent magnet. The magnetic conductive conductance pieces and the permanent magnet are rotated relative to one another and thereby, change the flux density on the converter element. This principle leads to undesired secondary effects on the bearing play of the moved components, which likewise, change the fields in the converter elements and, therewith, the measured results.

From DE 197 53 775 A1, it is known that with such a measuring device, with a Hall element as a path sensor, conductance pieces made from magnetically conductive material are used for steering the magnetic flow lines. In addition, EP 0 670 471 A1 describes an arrangement in which no part, which form the magnetic circuit, move relative to one another. Rather, here, the entire magnetic circuit rotates away via the electromagnetic converter. The measured effect is achieved by means of the fashioning of the magnetic, which ahs a defined air gap change over the angle of rotation.

### SUMMARY OF THE INVENTION

With a further form of a path sensor for determination of movement according to the above-described type with an electromagnetic converter element and a magnetic circuit, the present invention provides that all parts of the magnetic circuit are located during the path measurement in an unchanged position relative to one another, and the magnetic circuit and the converter element, preferably a Hall element, are movable relative to one another. A change of the magnetic field measurable from the converter element, according to the present invention, is affected through a change of the air gap in the magnetic circuit, whereby this corresponds during the movement with the converter element. Thus, the distance of the conductance pieces changes relative to one another.

In an advantageous manner, the conductance pieces of the magnetic circuit have a shape that includes the path of the converter element, which provides a predeterminable signal course in the converter element based on the change of the width of the air gap in the course of the path. The magnetic field that is variable in this manner, is largely determined through the width of the air gap as the measuring gap and permits a variable characteristic curve increase in a simple manner up to the point of angles or path measuring areas with signal changes by so-called plateau formation.

Preferably, the shape of the conductance pieces is such that a linear measuring curve in the trajectory is provided. Such a linear measuring curve is obtained when one chooses in the first approximation the gap width d of the air gap as reciprocal to the measured path x in the trajectory, that is, correspondingly d=1/x. The induction B in the converter element lies, then, in the area of Bₘₐₓ to Bₘᵢₙ, whereby the theoretical threshold value for Bₘᵢₙ=0 is achieved far outside of the conductance pieces.

With an advantageous embodiment, the path sensor is a linear path sensor and the trajectory of the relative movement of the magnetic circuit and the converter element is a straight line. According to another advantageous embodiment, the path sensor is a radial path sensor and the trajectory of the relative movement of the magnetic circuit and the converter element is a circle or a section of a circle.

In particular, with an arrangement as a linear path sensor, two arrangements of the magnetic circuit with respectively different polarizations of the magnetic can be opposed in the trajectory. In this manner, the induction B in the converter element, then, can change in the range of +Bₘₐₓ to −Bₘₐₓ.

### BRIEF DESCRIPTION OF THE DRAWINGS

FIG. 1 shows a path sensor for a linear path measurement with a suitable shape of the conductance pieces for a linear signal course;

FIG. 2 shows a path sensor for a linear path measurement with, respectively, two magnetic circuits oppositely disposed in the trajectory with, respectively, different polarizations of the magnets;

FIG. 3 shows a path sensor for a radial path measurement with a suitable shape of the conductance pieces for a linear signal course;

FIG. 4 shows a path sensor for a radial path measurement in a variation of the embodiment according to FIG. 3 with a similar, circular trajectory; and

FIG. 5 shows a path sensor for a radial path measurement with two magnets arranged about an inner, further conductance piece.

### DETAILED DESCRIPTION OF THE PREFERRED EMBODIMENTS

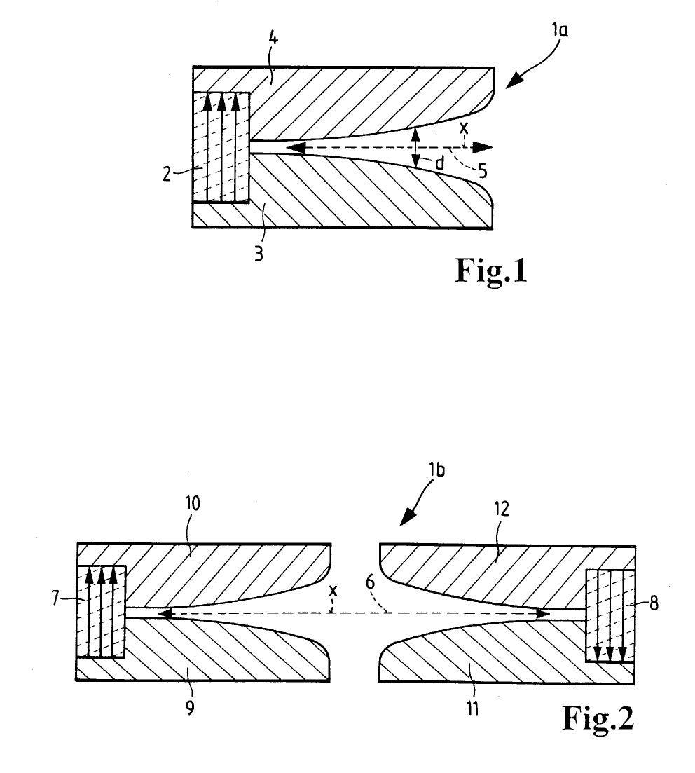

In FIG. 1, a linear path sensor is illustrated, which has a magnetic circuit comprising a permanent magnet 2 and two conductance pieces 3 and 4, for example, made from iron. On a trajectory 5, a Hall element (not shown here) is provided as an electromagnetic converter, whereby the range of measurement x in the trajectory 5 can take place by means of a relative movement of either the magnetic circuit or the Hall element. Through a suitable construction of the shape of the conductance pieces 3 and 4, an air gap with a changeable gap width d can be produced in the course of the range of measurement x, so that based on the change of the width d in the trajectory 5, without a specialized design of the magnet 2, a predeterminable signal course in the converter element is provided.

In FIG. 2, an embodiment of a linear path sensor 1b is shown, in which, respectively, two arrangements of the magnetic circuit with respectively different polarized magnets 7 and 8 and correspondingly formed conductance pieces 9, 10, 11, 12 are disposed in the trajectory 6 along the range of measurement x. The induction B in the converter element can change along the range of measurement x, then, in the range of +Bₘₐₓ to −Bₘₐₓ.

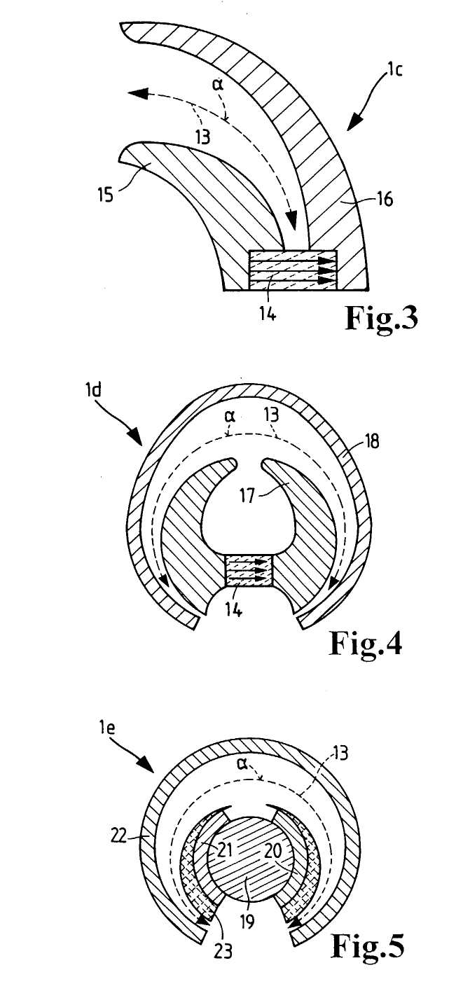

In the embodiment of FIG. 3, the trajectory 13 of relative movement along the range of measurement a is shown by sectors as a circular path, so that, here, a radial path sensor 1c is provided. The magnetic circuit is equipped with a magnet 14 and corresponding conductance pieces 15 and 16, whose design follows that of the principles explained with reference to FIG. 1 above.

A further embodiment in FIG. 4 shows in a variation of FIG. 3 the trajectory 13 of relative movement along the range of measurement a with an approximately complete circular path, so that also here, a radial path sensor 1d is provided. The magnetic circuit is equipped with the magnet 14 and a corresponding inner conductance piece 17 and an outer conductance piece 18.

In the embodiment shown in FIG. 5, a radial path sensor 1e is provided as a variation of the embodiment of FIG. 4, having a supplementary, inner conductance piece 19, on which radial or diametrical magnets 20 and 21 are applied. The conductance pieces 22 and 23 for changing the air gap are formed in accordance with FIG. 4.

It will be understood that each of the elements described above, or two or more together, may also find a useful application in other types of constructions differing from the types described above.

While the invention has been illustrated and described herein as a path sensor with an electromagnetic converter element, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. Path sensor, comprising at least one electromagnetic converter element and a magnetic circuit having at least one conductance piece (3, 4; 9, 10; 15, 16; 17, 18; 22, 23) and at least one magnet (2; 7, 8; 14; 20, 21), wherein by means of movement of an element, an effect of a magnetic flux measurable with the converter element is effected;
wherein all parts of the magnetic circuit are located relative to one another in an unchanged position during measurement of a path, wherein the magnetic circuit and the converter element are movable relative to one another; and
wherein a change of a magnetic field that is plottable by the converter element is effected by a change of an air gap (d) in the magnetic circuit, wherein said change corresponds with the converter element during said movement.

2. Path sensor as defined in claim 1, wherein the conductance pieces of the magnetic circuit have a shape that conforms to a path of the converter element, wherein a predeterminable signal course in the converter element is provided based on a change of a width (d) of the air gap in a trajectory (5; 6; 13).

3. Path sensor as defined in claim 2, wherein the shape of the conductance pieces (3, 4; 9, 10; 15, 16; 17, 18; 22, 23) is such that a linear measuring curve in the trajectory (5; 6; 13) is provided.

4. Path sensor as defined in claim 1, wherein the path sensor is a linear path sensor (1a; 1b) and a trajectory (5; 6) of relative movement of the magnetic circuit and the converter element is a straight line.

5. Path sensor as defined in claim 1, wherein the path sensor is a radial path sensor (1c; 1d; 1e) and a trajectory (13) of relative movement of the magnetic circuit and the converter element is a circle or a circular section.

6. Path sensor as defined in claim 5, wherein a supplementary, inner conductance piece (19) is provided, wherein on said inner conductance piece (19) radial or diametric magnetized magnets (20, 21) are disposed.

7. Path sensor as defined in claim 1, wherein two arrangements of the magnetic circuit having respectively different polarization of magnets (7, 8) are disposed opposite one another in a trajectory path.

8. Paths sensor as defined in claim 1, wherein the converter element is a Hall element.
